(19) United States
(12) Patent Application Publication
(10) Pub. No.: US 2010/0050693 A1
(43) Pub. Date: Mar. 4, 2010

(54) METHOD FOR PRODUCED LEAD-FREE CRYSTAL ICE, AND METHOD FOR MANUFACTURING DECORATIVE PLATE GLASS USING THE SAME

(76) Inventor: Jae Seok Jeon, Daegu (KR)

Correspondence Address: Muncy, Geissler, Olds & Lowe, PLLC, P.O. BOX 1364, FAIRFAX, VA, 22038-1364, US

(21) Appl. No.: 12/377,565

(22) PCT Filed: Nov. 24, 2006
(86) PCT No.: PCT/KR06/04995

§ 371 Date: Feb. 13, 2009

(30) Foreign Application Priority Data
Aug. 25, 2006 (KR) 10-2006-0081107

(51) Int. Cl. C03B 19/00; C03C 8/06; C03C 8/04; C03C 8/02

(52) U.S. Cl. 65/56; 501/25; 501/26; 501/21

(57) ABSTRACT

lead-free crystal ice that can be melt-adhered to a plate glass, has an average particle diameter (ø) of 0.2 mm to 1.0 mm, can be melted at a firing temperature (i.e. an internal temperature of a heating furnace) of 650 to 710° C., contains no heavy metals, and consists of optimal components present in optimal amounts. The lead-free crystal ice has the highest melting point within the range of 650 to 710° C. In addition, the surface of the lead-free crystal ice is not deformed or discolored in the atmosphere after the crystal ice is melt-adhered to the surface of a plate glass.

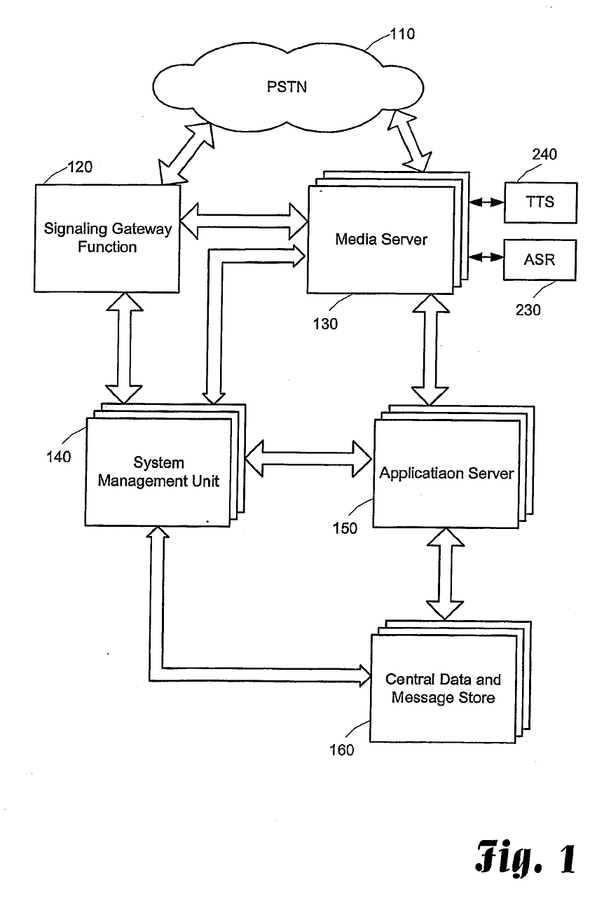

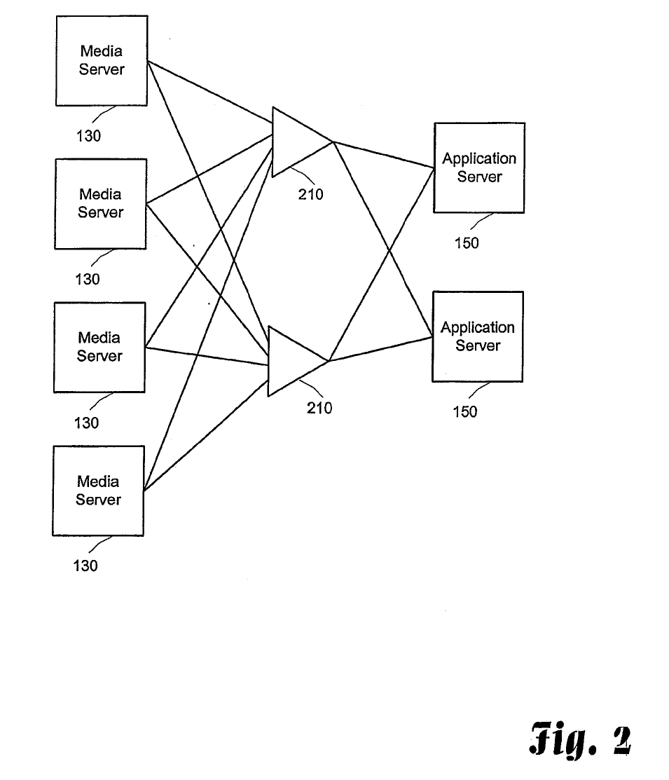

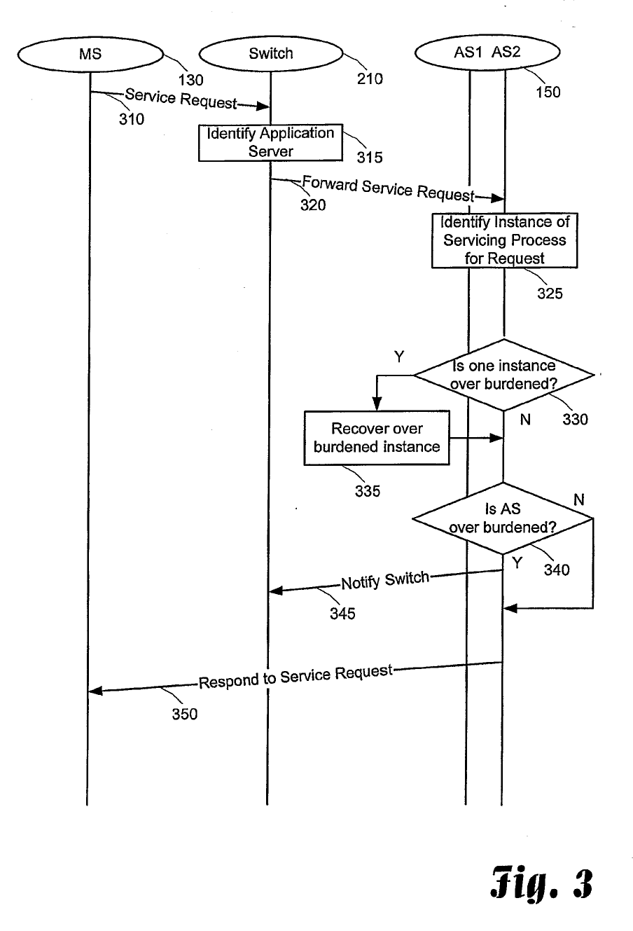

### TECHNICAL FIELD

The present invention relates to methods for producing crystal ice as a frit that is melt-adhered to the surface of a plate glass by heating.

### BACKGROUND ART

Frits, kinds of glass compositions, are very widely used in various application fields. Frits are mainly used as additives of pigments for glasses and tiles. In many cases, frits are also used as glazes of pottery and enamels of household goods. Since frits having an average particle size as small as 5 μm are used as glazes of pottery and enamels of household goods, the fine powder form of the frits is maintained. The processing temperature of the frits varies according to the intended use.

On the other hand, crystal ice (so-called a ‘glass powder’ as a frit is typically used for the purpose of decorating plate glasses. Crystal ice is also used in other applications and exists in various kinds. Crystal ice has a particle size comparable to that of sugar or salt, which is much larger than frits used as glazes of pottery and enamels of household goods.

As already known in the art, crystal ice is produced through a series of the following steps: Mixing of raw materials>melting>water bath>cooling>drying>pulverization>sieving>washing/drying.

The crystal ice thus produced contains some components (e.g., heavy metals) harmful to humans, and has a disadvantage in that the color is changed or the surface is deformed when being exposed to the atmosphere for a long period of time.

### DISCLOSURE

### Technical Problem

Therefore, it is one object of the present invention to provide methods for producing lead-free crystal ice that is not harmful to humans and whose surface is not deformed or discolored.

It is another object of the present invention to provide lead-free crystal ice produced by the methods.

It is another object of the present invention to provide methods for producing lead-free crystal ice that can be melt-adhered to a plate glass and is not harmful to humans and whose surface is minimally deformed and discolored.

It is another object of the present invention to provide lead-free crystal ice produced by the methods.

It is yet another object of the present invention to provide methods for manufacturing decorative plate glasses using the lead-free crystal ice that is harmless to humans.

### Technical Solution

In accordance with an aspect of the present invention for achieving the above objects, there is provided lead-free crystal ice that has an average particle diameter (ø) of 0.2 mm to 1.0 mm and consists of the following components present in the amounts (mol %) shown in any one of the following tables.

| Component | Amount (mol %) |
|---|---|
| Na₂O | 10-20 |
| ZnO | 10-30 |
| B₂O₃ | 20-40 |
| SiO₂ | 10-20 |
| TiO₂ | 0-5 |
| ZrO₂ | 0-5 |
| Al₂O₃ | 0-5 |
| K₂O | 3-10 |
| Mg | 5-10 |
| CaCO₃ | 3-10 |
| Nd | 0-5 |
| F | 0-5 |

| Component | Amount (mol %) |
|---|---|
| Na₂O | 10-20 |
| ZnO | 0-10 |
| B₂O₃ | 20-40 |
| SiO₂ | 10-30 |
| CaO | 5-10 |
| Al₂O₃ | 0-5 |
| BaO | 3-10 |
| SrO | 0-5 |
| Li₂CO₃ | 0-5 |
| Fe₂O | 0-3 |
| ZrO₂ | 0-3 |

| Component | Amount (mol %) |
|---|---|
| Na₂O | 10-20 |
| ZnO | 5-15 |
| B₂O₃ | 20-40 |
| SiO₂ | 10-30 |
| CaO | 3-10 |
| Al₂O₃ | 0-3 |
| BaO | 0-5 |
| Li₂CO₃ | 0-3 |
| SrO | 0-5 |

| | Amount | | Amount |
|---|---|---|---|
| Component | (mol %) | Component | (mol %) |
| SiO₂ (silica) | 10-30 | ZrO₂ (zirconia) | 0-5 |
| B₂O₃ (boron oxide) | 20-45 | Al₂O₃ (alumina) | 0-5 |
| Na₂O (sodium oxide) | 10-20 | K₂O (potassium oxide) | 3-10 |
| TiO₂ (titanium oxide) | 0-5 | Mg (magnesium) | 5-10 |
| ZnO (zinc oxide) | 5-30 | CaCO₃ (calcium | 3-10 |
| | | carbonate) | |
| Nd (niobium) | 0-5 | F (fluorine) | 0-5 |
| BaO (barium oxide) | 0-10 | SrO (strontium oxide) | 0-5 |

### ADVANTAGEOUS EFFECTS

The lead-free crystal ice of the present invention can be melt-adhered to the surface of a plate glass and is not harmful to humans. In addition, the surface of the lead-free crystal ice according to the present invention is minimally deformed and discolored. Furthermore, the lead-free crystal ice of the present invention can be advantageously used to manufacture decorative plate glasses with high productivity.

### BEST MODE FOR CARRYING OUT THE INVENTION

Preferred embodiments of the present invention will now be described in detail.

As mentioned above, the crystal ice of the present invention is produced through a series of the following steps: Mixing of raw materials>melting>water bath>cooling>drying>pulverization>sieving>washing/drying.

The first step of mixing raw materials is a crucial step determining the characteristics, quality and purity of the crystal ice and the melt-adhesiveness of the crystal ice to a plate glass.

In the first step, components of the crystal ice and amounts thereof vary according to the intended applications of the crystal ice. Although the crystal ice is used for the same application, components of the crystal ice and amounts thereof vary depending on a method for producing the crystal ice and an apparatus for implementing the method.

In embodiments of the present invention, the crystal ice is produced such that it can be melt-adhered to the surface of a plate glass. The crystal ice is produced by pulverizing glass frit base materials by dry-ball milling so that it has an average particle diameter (ø) of 0.2 mm to 1.0 mm. This average particle diameter is preferably achieved by sieving through a standard sieve of #30 to #100 (0.25 mm (ø) to 0.85 mm (ø)).

In embodiments of the present invention, the crystal ice is produced in such a manner that it is melt-adhered to the surface of a plate glass to manufacture a decorative plate glass with high productivity and is not harmful to humans. In addition, the crystal ice is produced such that its surface is minimally deformed and discolored.

Various techniques concerning glass frits containing no lead component harmful to the human body, which are not melt-adhered to the surface of plate glasses, have been proposed.

For example, Korean Patent Publication No. 1995-0006202 suggests lead-free glass frit compositions comprising various components present in the amounts shown in the respective tables. Further, U.S. Pat. No. 4,376,169 discloses frit compositions essentially comprising alkali metal oxides, B₂O₃, Al₂O₃, SiO₂, F, P₂O₅, ZnO and TiO₂. Further, U.S. Pat. No. 4,446,241 describes frit compositions comprising other oxides, such as Li₂, B₂O₃, SiO₂, ZrO₂ and a rare-earth oxide in which the weight ratio of the ZrO₂ to the rare-earth oxide is a critical value.

Further, U.S. Pat. No. 4,554,258 describes frit compositions comprising Bi₂O₂, B₂O₃, SiO₂ and an alkali metal oxide in which the alkali metal oxide is essentially present at a particular concentration.

Further, U.S. Pat. No. 4,590,171 describes frits consisting of Li₂O, Na₂O, BaO, Ba₂O₃, Al₂O₃, SiO₂, ZrO₂ and F.

As mentioned in the embodiments, various types of methods for producing lead-free glass frit compositions have been suggested. However, the frit compositions are processed into fine powders having an average particle size of about 5 μm so that they are used for pigments and enamels according to the applications and purposes of use. That is, the lead-free glass frits are used for high gloss of products, enamels of tableware and paints (glass mixtures for coloration). For example, Korean Patent Publication No. 95-0006202 mentions the production of a slip using a lead-free glass frit sufficient to perform screen printing. Further, Korean Patent Publication No. 90-003138 mentions a fused glass composition for coloration using a frit having an average particle diameter not larger than 5 μm.

The advantage of the lead-free glass frit compositions is the absence of lead. However, the lead-free glass frit compositions have a disadvantage in that they cannot be used as frits (i.e. crystal ice) having a size suitable to be melt-adhered to the surface of plate glasses so as to leave decorative irregularities on the plate glasses.

In conclusion, as in the embodiments of the present invention, the components and amounts thereof of the crystal ice, which has a diameter (ø) of about 0.2 mm to about 1.0 mm suitable to be melt-adhered to the surface of a plate glass so as to leave decorative irregularities on the plate glass, must be different from those of general glasses and glass frits for improving the surface gloss of porcelain or enamels.

A glass or glass frit powder for improving the surface gloss of porcelain or enamel is coated on the surface of an object and is completely melted to achieve glossy effects. In contrast, when crystal ice is completely melted on a plate glass, no decorative irregularity is left on the plate glass. Therefore, crystal ice must consist of components present in amounts suitable for the formation of decorative irregularities. In addition, components and amounts thereof of crystal ice must be determined taking into consideration the production conditions (e.g., heating temperature) of the crystal ice for the formation of decorative irregularities. Furthermore, it is preferred that crystal ice comprises no pigment or additive pure other than pure frit components.

Decorative irregularities are formed on a plate glass through the following mechanism. First, crystal ice is appropriately heated on the plate glass. The heat substantially changes the phase of the crystal ice to a liquid phase. At this time, the liquid-phase crystal ice attracts adjacent liquid-phase crystal ice due to surface tension to form spherical dewdrops on the plate glass. Then, the spherical dewdrops are cooled to maintain their shape.

Crystal ice has been produced by ceramic manufacturers, some of which currently produce decorative glasses.

For example, “Transparent Glass colors, Series H31”, which is a technical explanatory statement provided by Heraeus, 1994, mentions that series H-31 has a melting point of 540° C. to 600° C., the temperature of a heating furnace must be slowly increased and a ventilator must be operated until the temperature of the heating furnace reaches 400° C. Similar explanations are given in technical explanatory statements of #50283 and #47C328, which are available from ‘Ferrow’ and ‘Jonson Cookson Mettey’, respectively.

The crystal ice produced under the production conditions described in the technical explanatory statements contains lead and heavy metals. Further, when the crystal ice is used to manufacture decorative plate glasses, it suffers from the following limitations.

Firstly, a method based on slow heating and slow cooling requires the use of a general heating furnace, which limits the manufacturing throughput of decorative plate glasses. Since this method results in an extremely low daily manufacturing throughput of decorative plate glasses, it is not suitable for mass production.

Secondly, plate glasses as bases are liable to be damaged due to the difference in the coefficient of expansion (contraction) between the plate glasses and the crystal ice during slow heating and cooling of the plate glasses.

Thirdly, since the crystal ice contains lead and heavy metals, the surface of the crystal ice melt-adhered to plate glasses in the atmosphere is liable to be corroded, resulting in discoloration of the crystal ice.

Techniques concerning the melt-adhesion of crystal ice to plate glasses have limitations in practical use, and in actuality, they are not substantially used.

According to the embodiments of the present invention, crystal ice is melt-adhered to the surface of a plate glass to form decorative irregularities on the plate glass by the method known in Korean Patent No. 295234 issued to the present inventor, entitled “preparation method of decorative glass plate”. That is, the method involving ‘rapid heating and rapid cooling’ is employed to melt-adhere crystal ice to the surface of a plate glass to form decorative irregularities on the plate glass.

The present inventor has found that the rapid heating and rapid cooling essentially require the use of tempering furnace equipment, particularly a horizontal tempering furnace. When the method involving rapid heating and rapid cooling is employed to melt-adhere crystal ice to the surface of a plate glass, the manufacturing yield of a decorative plate glass can be markedly increased.

At this time, the melting point of crystal ice must be taken into consideration in order to employ the method involving rapid heating and rapid cooling. The softening temperature of general glasses is approximately 530° C., and the melting point of general crystal ice melt-adhered to general plate glasses is between 540° C. and 600° C. (firing range), which is the internal temperature range of a heating furnace.

In the embodiments of the present invention, the internal temperature of a heating furnace required upon rapid heating and rapid cooling is preferably adjusted to the temperature range of 650° C. to 710° C. (firing range). The components and amounts thereof of crystal ice must be selected such that the crystal ice can have the highest melting point within the range of 650° C. to 710° C. The internal temperature of the heating furnace is preferably that of a heating furnace of a horizontal tempering furnace.

The present inventor has conducted repeated studies to search optimal components and optimal amounts thereof of lead-free crystal ice containing no heavy metals while maintaining the internal temperature of a heating furnace, where the crystal ice is melted, at 650 to 710° C.

In the course of the studies, the present inventor has discovered that the melting temperature range of crystal ice could be varied due to the presence of some components and that lead (Pb) and lithium (Li), which do harm to the human skin, caused the surface of crystal ice to be corroded and discolored.

Also, the present inventor has conducted repeated studies to produce novel lead-free crystal ice that is melt-adhered to the surface of a plate glass, has an average particle diameter (ø) ranging from 0.2 mm to 1.0 mm, is melted at a firing temperature (i.e. an internal temperature of a heating furnace) of 650 to 710° C. at which the surface is unchanged in the atmosphere after being melt-adhered to the surface of the plate glass, and contains no lead and heavy metals harmful to humans.

According to these studies, experiments were performed to confirm what kinds of components are preferably used instead of heavy metals to constitute crystal ice as a frit, whether or not melt-adhesion can be actually carried out, and whether or not the transparency of crystal ice is maintained.

As a result of hundreds of experiments by the present inventor, it was confirmed that boron oxide (B₂O₃), sodium oxide (Na₂O), zinc oxide (ZnO) and calcium carbonate (CaCO₃) as main constituent components could be used instead of lead (Pb), cadmium (Cd) and lithium (Li), which are harmful to humans among the constituent components of general crystal ice shown in Table 1.

TABLE 1

| Amount & | Amount (mol %) | | |
|---|---|---|---|
| Sample No | | Cookson Mettey | |
| Component | Heraeus, H-31 | #47C328 | Ferro #50283 |
| SiO₂ | 19.8 | 16.9 | 16.2 |
| B₂O₃ | — | — | — |
| Na₂O | 0.12 | 0.12 | 0.05 |
| ZnO | — | — | — |
| PbO | 76.7 | 82.4 | 83.4 |
| Cd | 4 | 14 | 8 |
| K₂O | 2.63 | 0.10 | — |
| Fe₂O₃ | 0.09 | 0.05 | 0.04 |
| CaO | 0.09 | 0.08 | 0.06 |
| Al₂O₃ | 0.17 | 0.12 | 0.06 |

The following tables 2 to 4 show components and amounts thereof of lead-free crystal ice according to the preferred embodiments of the present invention. Referring to Tables 2 to 4, the lead-free crystal ice consists of boron oxide (B₂O₃), sodium oxide (Na₂O), zinc oxide (ZnO) and calcium carbonate (CaCO₃) instead of lead (Pb), cadmium (Cd) and lithium (Li), which are constituent components of general crystal ice.

TABLE 2

| Component | Amount (mol %) |
|---|---|
| Na₂O | 10-20 |
| ZnO | 10-30 |
| B₂O₃ | 20-40 |
| SiO₂ | 10-20 |
| TiO₂ | 0-5 |
| ZrO₂ | 0-5 |
| Al₂O₃ | 0-5 |
| K₂O | 3-10 |
| Mg | 5-10 |
| CaCO₃ | 3-10 |
| Nd | 0-5 |
| F | 0-5 |

TABLE 3

| Component | Amount (mol %) |
|---|---|
| Na₂O | 10-20 |
| ZnO | 0-10 |
| B₂O₃ | 20-40 |
| SiO₂ | 10-30 |
| CaO | 5-10 |
| Al₂O₃ | 0-5 |
| BaO | 3-10 |
| SrO | 0-5 |
| Li₂CO₃ | 0-5 |
| Fe₂O | 0-3 |
| ZrO₂ | 0-3 |

TABLE 4

| Component | Amount (mol %) |
|---|---|
| Na₂O | 10-20 |
| ZnO | 5-15 |
| B₂O₃ | 20-40 |
| SiO₂ | 10-30 |
| CaO | 3-10 |
| Al₂O₃ | 0-3 |
| BaO | 0-5 |
| Li₂CO₃ | 0-3 |
| SrO | 0-5 |

The crystal ice according to the embodiments of the present invention had the components present in the amounts shown in Tables 2 to 4, could be melt-adhered to plate glasses, had an average particle diameter (ø) of 0.2 mm to 1.0 mm, was melted at a firing temperature (i.e. an internal temperature of a heating furnace) of 650 to 710° C. at which the surface was unchanged in the atmosphere after being melt-adhered to the surface of the plate glasses, and contained no lead and heavy metals harmful to humans.

The lead-free crystal ice consisting of the components defined above was melt-adhered to a plate glass. As a result, the crystal ice was successfully adhered to the surface of the plate glass and shined brightly. No change in the shape and color of the crystal ice in the atmosphere was observed. Due to the absence of heavy metals, corrosion of the crystal ice and escaping of heavy metals from the surface of the crystal ice did not occur.

Further, the present inventor has found that barium oxide (BaO) and strontium oxide (SrO) affected the transparency of the crystal ice. These components increased the transparency of the crystal ice. Based on these findings, preferred components and amounts thereof of the lead-free crystal ice were selected as shown in Table 5.

TABLE 5

| | Amount | | Amount |
|---|---|---|---|
| Component | (mol %) | Component | (mol %) |
| SiO₂ (silica) | 10-30 | ZrO₂ (zirconia) | 0-5 |
| B₂O₃ (boron oxide) | 20-45 | Al₂O₃ (alumina) | 0-5 |
| Na₂O (sodium oxide) | 10-20 | K₂O (potassium oxide) | 3-10 |
| TiO₂ (titanium oxide) | 0-5 | Mg (magnesium) | 5-10 |
| ZnO (zinc oxide) | 5-30 | CaCO₃ (calcium | 3-10 |
| | | carbonate) | |
| Nd (niobium) | 0-5 | F (fluorine) | 0-5 |
| BaO (barium oxide) | 0-10 | SrO (strontium oxide) | 0-5 |

When the content ranges of the main components of the lead-free crystal ice according to the embodiments of the present invention were compared with those described in Korean Patent Publication No. 95-0006202, there were great differences in terms of SiO₂, Na₂O and B₂O₃ contents. The ZnO contents were similar in both cases.

When the SiO₂ content of the crystal ice was increased, the crystal ice was likely to fall off from the plate glass without being melt-adhered, which was confirmed through an actual experiment.

### Experimental Examples 1 to 6

### Mixing Ratios

Frit components were mixed in accordance with the respective compositions indicated in Table 6. The components and amounts thereof of the frit compositions were measured according to the KSL-1204 standard method. The experimental results are shown in Table 6.

TABLE 6

| | Amounts (mol %) | | | | | |
|---|---|---|---|---|---|---|
| | Exp. | Exp. | Exp. | Exp. | Exp. | Exp. |
| Component | Ex. 1 | Ex. 2 | Ex. 3 | Ex. 4 | Ex. 5 | Ex. 6 |
| SiO₂ | 15 | 18 | 28-35 | 18 | 28 | 24 |
| B₂O₃ | 30 | 22 | 25 | 22 | 30 | 35 |
| Na₂O | 18 | 25 | 14 | 25 | 18 | 18 |
| ZnO | 22 | 25 | | 30 | 6 | 10 |
| Mg | 8 | | | | | |
| K₂O | 6 | | 7-13 | | | |
| CaCO₃ | 7 | | | 3-10 | 5-10 | 5-10 |
| TiO₂ | 0-5 | | | 0-5 | | |
| Nd | 0-5 | | | | | |
| ZrO₂ | 0-5 | | | | 0-3 | |
| Al₂O₃ | 0-5 | | | | 0-5 | 0-5 |
| BaO | | | 7 | | 3-10 | 0-5 |
| Li₂CO₃ | | | 8 | | 0-5 | 0-5 |
| Fe₂O | 0-5 | | | | 0-3 | |
| SrO | 0-5 | | | | | 0-5 |
| Transparency | Good | Good | Good | Good | Good | Good |
| and gloss | | | | | | |
| Chemical | Good | Good | Weak | Good | Good | Good |
| resistance | | | | | | |
| Melt- | Good | Poor | Good | Poor | Good | Good |
| adhesiveness | | | | | | |

In Experimental Example 1, the surface of a plate glass, to which the crystal ice was melt-adhered, was highly glossy and transparent. The melt-adhesiveness of the crystal ice turned out to be good. For the evaluation of chemical resistance, the crystal ice melt-adhered to a plate glass was dipped in a 4% acetic acid solution for one hour. No change was observed.

In Experimental Example 2, the melting temperature of the crystal ice was successfully lowered. However, the melt-adhesion of the crystal ice to a plate glass was poor and peeling of the crystal ice was observed in some areas due to the difference in expansion coefficient between the crystal ice and the plate glass.

In Experimental Example 3, no peeling of the crystal ice from a plate glass was observed because the difference in expansion coefficient between the crystal ice and the plate glass was suitably controlled at the melting point of the crystal ice. However, due to the use of Li₂CO₃ and K₂O instead of lead (Pb), the crystal ice showed poor chemical resistance.

In Experimental Example 4, the melt-adhesion of the crystal ice to a plate glass was poor and peeling of the crystal ice was observed in some areas due to the large difference in expansion coefficient between the crystal ice and the plate glass, as in Experimental Example 2. The chemical resistance of the crystal ice was improved by the use of TiO₂.

In Experimental Example 5, the content of SiO₂ was increased and the content of ZnO was considerably decreased, resulting in a slight deterioration in chemical resistance and transparency. To solve these problems, BaO and SrO were added in appropriate amounts. As a result, the transparency, melt-adhesiveness and chemical resistance of the crystal ice were improved.

In Experimental Example 6, the content of SiO₂ was slightly increased and the content of ZnO was decreased, resulting in a deterioration in transparency and gloss.

To solve these problems, BaO, SrO and a small amount of Li₂CO₃ were added. As a result, the transparency, gloss, melt-adhesiveness and chemical resistance of the crystal ice were improved.

In addition to these experiments, various experiments were further performed by varying the experimental conditions. As a result, the mixing ratio between the main components, i.e. SiO₂, B₂O₃, Na₂O and ZnO, of the crystal ice turned out to be very important.

Particularly, poor chemical resistance of the crystal ice caused by considerably decreasing the content of SiO₂ to 30% or less could be solved by increasing the content of B₂O₃ and mixing the other components in appropriate amounts. The chemical resistance of the crystal ice was evaluated by dipping the crystal ice in a 4% acetic acid solution for one hour according to the KSL-1204 standard method. The melt-adhesiveness and peeling of the crystal ice were evaluated in accordance with the respective procedures described in the KSL standard method.

The lead-free crystal ice produced in Experimental Examples 1 to 6 had a melting point within the firing range (i.e. the internal temperature of a heating furnace) of 650° C. to 700° C. and an expansion coefficient of 90×10⁻⁷/° C. to 91×10⁻⁷/° C.

When the lead-free crystal ice, which consists of the glass frit compositions defined above, according to the embodiments of the present invention was melt-adhered to the surface of a plate glass, it had a maximum melting point at which irregularities, like dewdrops, were formed and showed excellent performance in an acid resistance test.

The lead-free crystal ice, which consists of the components present in the amounts shown in any one of Tables 2 to 5 and has an average particle diameter (ø) of 0.2 mm to 1.0 mm, is melt-adhered to the surface of a plate glass to manufacture a decorative plate glass having a decorative pattern. The manufacturing procedure will be briefly summarized below.

First, the lead-free crystal ice, which consists of the components present in the amounts defined above and has the average particle diameter defined above, is adhered to the surface of a plate glass in a particular pattern. Thereafter, the plate glass, to which the crystal ice is adhered, is placed in a horizontal tempering furnace, followed by rapid heating to 650° C. to 710° C. (firing temperature), which is the internal temperature of a heating furnace, for several minutes. When the temperature reaches the highest melting point, the heated plate glass is rapidly taken out of the furnace and rapidly cooled in a cooling unit for several minutes to complete the manufacture of a decorative plate glass.

The decorative plate glass thus manufactured shows good transparency, melt-adhesiveness and chemical resistance. In addition, since the lead-free crystal ice is melt-adhered to a plate glass, escaping of heavy metals harmful to humans from the surface of the crystal ice does not occur.

Although the present invention has been described herein with reference to the foregoing embodiments, those skilled in the art will appreciate that various modifications are possible, without departing from the scope and spirit of the invention as disclosed in the accompanying claims. The scope of the invention is, therefore, indicated by the appended claims and their equivalents, rather than by these embodiments.

### INDUSTRIAL APPLICABILITY

As apparent from the above description, the crystal ice of the present invention can be used to manufacture decorative plate glasses.

1. A method for producing lead-free crystal ice that is melt-adhered to the surface of a plate glass, the method comprising the steps of pulverizing glass frit base materials to produce crystal ice whose average particle diameter (ø) of 0.2 mm to 1.0 mm wherein the crystal ice is melted at a firing temperature (an internal temperature of a heating furnace) of 650 to 710° C.

2. The method according to claim 1, wherein the crystal ice comprises components shown in a following table:

| Component | Amount (mol %) |
|---|---|
| Na₂O | 10-20 |
| ZnO | 10-30 |
| B₂O₃ | 20-40 |
| SiO₂ | 10-20 |
| TiO₂ | 0-5 |
| ZrO₂ | 0-5 |
| Al₂O₃ | 0-5 |
| K₂O | 3-10 |
| Mg | 5-10 |
| CaCO₃ | 3-10 |
| Nd | 0-5 |
| F | 0-5 |

3. (canceled)

4. The method according to claim 1, wherein the crystal ice comprises components shown in a following table:

| Component | Amount (mol %) |
|---|---|
| Na₂O | 10-20 |
| ZnO | 0-10 |
| B₂O₃ | 20-40 |
| SiO₂ | 10-30 |
| CaO | 5-10 |
| Al₂O₃ | 0-5 |
| BaO | 3-10 |
| SrO | 0-5 |
| Li₂CO₃ | 0-5 |
| Fe₂O | 0-3 |
| ZrO₂ | 0-3 |

5. (canceled)

6. The method according to claim 1, wherein the crystal ice comprises components shown in a following table:

| Component | Amount (mol %) |
|---|---|
| Na₂O | 10-20 |
| ZnO | 5-15 |
| B₂O₃ | 20-40 |
| SiO₂ | 10-30 |
| CaO | 3-10 |
| Al₂O₃ | 0-3 |
| BaO | 0-5 |
| Li₂CO₃ | 0-3 |
| SrO | 0-5 |

7. Lead-free crystal ice having an average particle diameter (ø) of 0.2 mm to 1.0 mm and consisting of the components present in the amounts (mol %) shown in the following table:

| Component | Amount (mol %) |
|---|---|
| Na₂O | 10-20 |
| ZnO | 10-30 |
| B₂O₃ | 20-40 |
| SiO₂ | 10-20 |
| TiO₂ | 0-5 |
| ZrO₂ | 0-5 |
| Al₂O₃ | 0-5 |
| K₂O | 3-10 |
| Mg | 5-10 |
| CaCO₃ | 3-10 |
| Nd | 0-5 |
| F | 0-5 |

8. Lead-free crystal ice having an average particle diameter (ø) of 0.2 mm to 1.0 mm and consisting of the components present in the amounts (mol %) shown in the following table:

| Component | Amount (mol %) |
|---|---|
| Na₂O | 10-20 |
| ZnO | 0-10 |
| B₂O₃ | 20-40 |
| SiO₂ | 10-30 |
| CaO | 5-10 |
| Al₂O₃ | 0-5 |
| BaO | 3-10 |
| SrO | 0-5 |
| Li₂CO₃ | 0-5 |
| Fe₂O | 0-3 |
| ZrO₂ | 0-3 |

9. Lead-free crystal ice having an average particle diameter (ø) of 0.2 mm to 1.0 mm and consisting of the components present in the amounts (mol %) shown in the following table:

| Component | Amount (mol %) |
|---|---|
| Na₂O | 10-20 |
| ZnO | 5-15 |
| B₂O₃ | 20-40 |
| SiO₂ | 10-30 |
| CaO | 3-10 |
| Al₂O₃ | 0-3 |
| BaO | 0-5 |
| Li₂CO₃ | 0-3 |
| SrO | 0-5 |

10. Lead-free crystal ice having an average particle diameter (ø) of 0.2 mm to 1.0 mm and consisting of the components present in the amounts (mol %) shown in the following table:

| | | | |
|---|---|---|---|
| | Amount | | Amount |
| Component | (mol %) | Component | (mol %) |
| | | | |
|---|---|---|---|
| SiO₂ (silica) | 10-30 | ZrO₂ (zirconia) | 0-5 |
| B₂O₃ (boron oxide) | 20-45 | Al₂O₃ (alumina) | 0-5 |
| Na₂O (sodium oxide) | 10-20 | K₂O (potassium oxide) | 3-10 |
| TiO₂ (titanium oxide) | 0-5 | Mg (magnesium) | 5-10 |
| ZnO (zinc oxide) | 5-30 | CaCO₃ (calcium | 3-10 |
| | | carbonate) | |
| Nd (niobium) | 0-5 | F (fluorine) | 0-5 |
| BaO (barium oxide) | 0-10 | SrO (strontium oxide) | 0-5 |

11. The lead-free crystal ice according to claim 7, wherein the crystal ice is melted at a firing temperature (an internal temperature of a heating furnace) of to 710° C.

12. (canceled)

13. (canceled)

14. (canceled)

15. (canceled)
